(19) United States
(12) Patent Application Publication
(10) Pub. No.: US 2017/0199300 A1
(43) Pub. Date: Jul. 13, 2017

(54) NUMERICAL METHOD FOR CALCULATING GAS PROPERTIES WITHOUT RESERVOIR FLUID CHARACTERIZATION

(71) Applicant: Saudi Arabian Oil Company, Dhahran (SA)

(72) Inventors: Nasser M. Al-Hajri, Eastern Province (SA); Mohammed D. Al-Ajmi, Alkhobar (SA)

(21) Appl. No.: 14/994,776

(22) Filed: Jan. 13, 2016

(51) Int. Cl. G01V 9/00

(52) U.S. Cl. CPC G01V 9/00

(57) ABSTRACT

Gas pressure gradient data of a reservoir interval is received. A gas mixture molecular weight is initialized. A gas deviation factor of the reservoir interval is iteratively calculated by a computer. The iterative calculation includes calculating a first gas deviation factor using a gas specific gravity based on the gas mixture molecular weight, calculating a second gas deviation factor based on the gas mixture molecular weight and the gas pressure gradient data, calculating a difference indicator indicating difference between the first and the second gas deviation factor, updating the gas mixture molecular weight based on the difference indicator, re-calculating the first and the second gas deviation factor and the difference indicator based on the updated gas mixture molecular weight, and outputting the gas deviation factor when the difference indicator is smaller than a pre-determined threshold.

### BACKGROUND

Gas deviation factor and other gas reservoir fluid properties, such as formation volume factor, density, and viscosity, are normally obtained from reservoir fluid characterization, for example Pressure-Volume-Temperature (PVT) experimental analysis; a time consuming and expensive process. To maximize petroleum production and total recovery of hydrocarbons, it is important for petroleum companies to be able to predict gas reservoir fluid properties without the need for reservoir fluid characterization.

### SUMMARY

The present disclosure relates to a numerical method for calculating gas properties without reservoir fluid characterization.

Gas pressure gradient data of a reservoir interval is received. A gas mixture molecular weight is initialized. A gas deviation factor of the reservoir interval is iteratively calculated by a computer. The iterative calculation includes calculating a first gas deviation factor using a gas specific gravity based on the gas mixture molecular weight, calculating a second gas deviation factor based on the gas mixture molecular weight and the gas pressure gradient data, calculating a difference indicator indicating difference between the first and the second gas deviation factor, updating the gas mixture molecular weight based on the difference indicator, re-calculating the first and the second gas deviation factor and the difference indicator based on the updated gas mixture molecular weight, and outputting the gas deviation factor when the difference indicator is smaller than a pre-determined threshold.

Some implementations can include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

For example, in one implementation, a computer-implemented method includes: receiving gas pressure gradient data of a reservoir interval; initializing a gas mixture molecular weight; and iteratively calculating, by a computer, a gas deviation factor of the reservoir interval, wherein the iterative calculation includes: calculating a first gas deviation factor using a gas specific gravity based on the gas mixture molecular weight; calculating a second gas deviation factor based on the gas mixture molecular weight and the gas pressure gradient data; calculating a difference indicator indicating difference between the first and the second gas deviation factor; updating the gas mixture molecular weight based on the difference indicator; re-calculating the first and the second gas deviation factor and the difference indicator based on the updated gas mixture molecular weight; and outputting the gas deviation factor when the difference indicator is smaller than a pre-determined threshold.

The foregoing and other implementations can each optionally include one or more of the following features, alone or in combination:

A first aspect, combinable with the general implementation, wherein the gas pressure gradient data includes fluid temperatures and pressures at an initial depth and a final depth of the reservoir interval.

A second aspect, combinable with the general implementation, wherein the second gas deviation factor is calculated as

$$\frac{{P}_{avg} {MM}_{a} ( {D}_{f} - {D}_{i} )}{144 ( {P}_{f} - {P}_{i} ) {RT}_{avg}} ,$$

where

$${P}_{avg} = \frac{{P}_{i} + {P}_{f}}{2}$$

is an average pressure across the reservoir interval,

$${T}_{avg} = \frac{{T}_{i} + {T}_{f}}{2}$$

is an average temperature across the reservoir interval, Dᵢ and D_{f} are the initial and the final depth of the reservoir interval, respectively, Pᵢ and P_{f} are fluid pressures at the initial and the final depth of the reservoir interval, respectively, Tᵢ and T_{f} are fluid temperatures at the initial and the final depth of the reservoir interval, respectively, MMₐ is the gas mixture molecular weight, and R is a universal gas constant.

A third aspect, combinable with the general implementation, wherein calculating the first gas deviation factor using the gas specific gravity based on the gas mixture molecular weight further comprises calculating pseudo critical temperature and pressure based on the gas specific gravity; calculating pseudo reduced temperature and pressure based on the pseudo critical temperature and pressure; and calculating the first gas deviation factor from Standing and Katz charts based on the pseudo reduced temperature and pressure.

A fourth aspect, combinable with the general implementation, wherein updating the gas mixture molecular weight includes increasing the gas mixture molecular weight by a pre-determined amount.

A fifth aspect, combinable with the general implementation, wherein outputting the gas deviation factor includes outputting one of the first gas deviation factor, the second gas deviation factor, or an average of the first and the second gas deviation factor.

A sixth aspect, combinable with the general implementation, wherein initializing the gas mixture molecular weight includes initializing the gas mixture molecular weight to a least possible value of gas mixture molecular weight.

The subject matter described in this specification can be implemented in particular implementations so as to realize one or more of the following advantages. The described subject matter determines gas properties without reservoir fluid experimental analysis which can only be performed if reservoir fluid samples are collected. A numerical iterative methodology is used to calculate gas properties based on field measurements of reservoir pressures and temperatures at different depths. The described approach predicts gas properties at a reduced cost without collecting reservoir fluid samples. Also, acquiring the gas properties using the described numerical methodology is shorter in duration compared to Pressure-Volume-Temperature (PVT) lab analysis. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a flow chart of an example method for deriving a z-factor based on gas pressure gradient data, according to an implementation.

FIG. 2 illustrates gas pressure gradient data, according to an implementation.

FIG. 3 illustrates z-factor calculation across a reservoir interval, according to an implementation.

FIG. 4 is a flow chart of an example method to numerically calculate a z-factor using an iterative methodology, according to an implementation.

FIG. 5 is a block diagram illustrating an exemplary distributed computer system (EDCS) used to numerically calculate gas properties without reservoir fluid characterization, according to an implementation.

Like reference numbers and designations in the various drawings indicate like elements.

### DETAILED DESCRIPTION

The present detailed description relates to a numerical method for calculating gas properties without reservoir fluid characterization and is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

At a high-level is described a numerical iterative methodology to compute gas deviation factor and other gas reservoir fluid properties such as formation volume factor, density, and viscosity without the need for Pressure-Volume-Temperature (PVT) experimental analysis. The approach, instead, utilizes field measurements of reservoir pressure, temperature, and gas gradient to deduce gas deviation factor and other properties by applying the real gas equation of state and other correlations which are well-known for their accuracy and repeatability.

Gas deviation factor, which is also called gas compressibility factor or z-factor, is an important gas property which measures how much thermodynamic properties of a real gas deviate from those expected of an ideal gas. An ideal gas is a hypothetical gas that has the following properties: the volume of gas molecules is insignificant compared to the total volume of the gas, no attractive or repulsive forces exist among the molecules or between the molecules, and the container walls and all molecules collisions are perfectly elastic.

Existing approaches of determining a z-factor are based on the above-described PVT experimental analysis of a reservoir fluid sample. For example, the following two experimental based methods can be used to determine gas mixture pseudo critical properties from which the z-factor can be determined.

The first method is applied when the gas composition is known. The gas mixture pseudo critical properties are calculated as a weighted average of individual components' critical properties as follows:

T_{pc}=Σᵢ₌₁ⁿT_{ci}yᵢ (1)

P_{pc}=Σᵢ₌₁ⁿP_{ci}yᵢ (2),

where:

T_{pc} is the pseudo critical temperature (R),

P_{pc} is the pseudo critical pressure (psi),

T_{ci} is the critical temperature of the i^{th} gas component (R),

P_{ci} is the critical pressure of the i^{th} gas component (psi), and

yᵢ is the composition of the i^{th} gas component.

The second method is applied when the gas composition is unknown. Empirical equations are used to compute the gas mixture pseudo critical properties as a function of gas specific gravity which is calculated as follows:

$${γ}_{g} = \frac{{MM}_{a}}{{M}_{air}} = \frac{{MM}_{a}}{28.97} , \qquad ( 3 )$$

where:

γ_{g} is the gas specific gravity,

Mₐᵢᵣ is the dry air density (lbm/ft³), and

MMₐ is the gas mixture molecular weight.

The gas mixture pseudo critical properties are calculated using the following empirical equations based on Sutton's correlation:

P_{pc}=756.8−131.0γ_{g}−3.6γ_{g}² (4)

T_{pc}=169.2+349.5γ_{g}−74.0γ_{g}² (5).

In the above two methods, experimental analysis is required to obtain the gas composition to apply equations (1) and (2) or the gas specific gravity to apply equations (4) and (5).

From the gas mixture pseudo critical properties and based on the Law of Corresponding States which says that all pure gases have the same z-factor at the same values of reduced pressure and reduced temperature, gas mixture pseudo reduced properties are derived as:

$$\begin{matrix}{T}_{pr} = \frac{T}{{T}_{pc}} & ( 6 ) \\ {P}_{pr} = \frac{P}{{P}_{pc}} , & ( 7 )\end{matrix}$$

where:

Pₚᵣ is the pseudo reduced pressure (psi),

P_{pc} is the pseudo critical pressure (psi),

Tₚᵣ is the pseudo reduced temperature (R),

T_{pc} is the pseudo critical temperature (R),

P is the pressure (psia), and

T is the temperature (R°).

Based on the pseudo reduced gas properties, the z-factor is determined numerically by a correlation or graphically from Standing and Katz charts which relate pseudo reduced gas properties to the z-factor. As discussed above, the existing approaches to determine the z-factor require experimental analysis which can only be performed if reservoir fluid samples are collected.

The described approach in this disclosure derives the z-factor as a function of gas pressure gradient data. The described approach uses an iterative methodology to calculate the z-factor based on gas pressure gradient data without reservoir fluid experimental analysis.

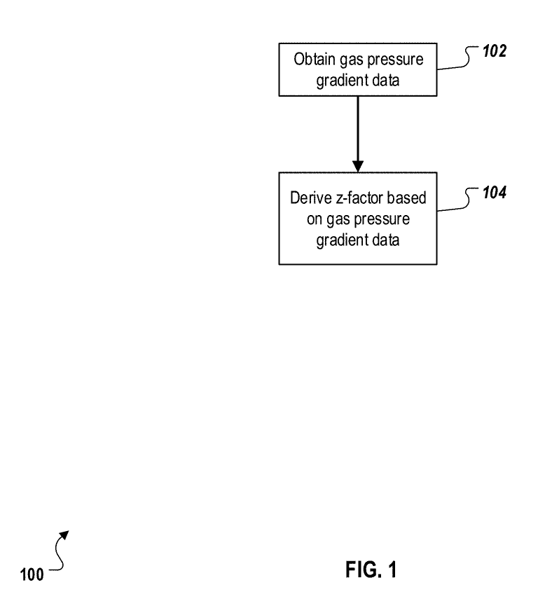

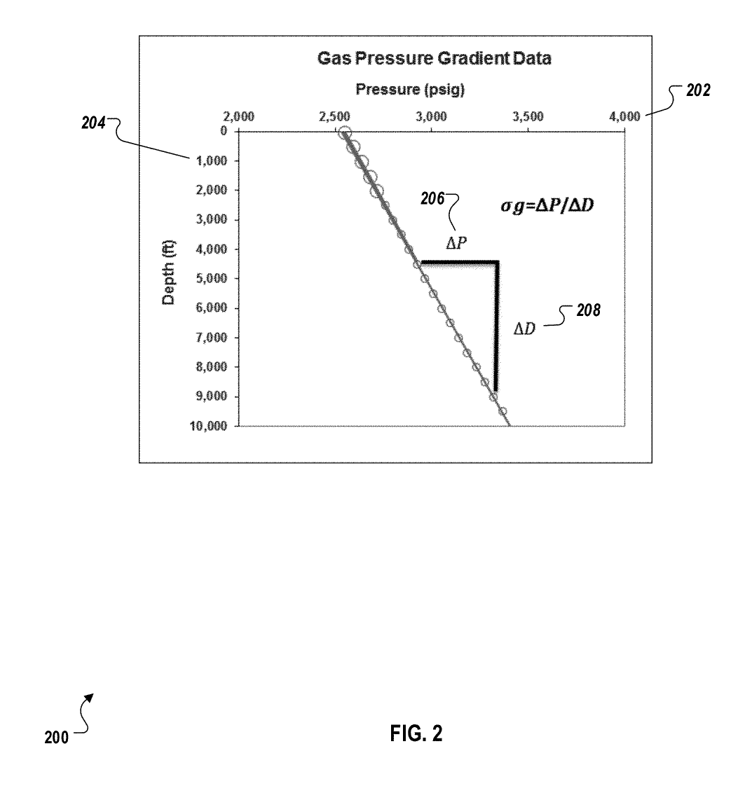

FIG. 1 is a flow chart of an example method 100 for deriving a z-factor based on gas pressure gradient data, according to an implementation. For clarity of presentation, the description that follows generally describes method 100 in the context of FIGS. 2-5. However, it will be understood that method 100 may be performed, for example, by any suitable system, environment, software, and hardware, or a combination of systems, environments, software, and hardware as appropriate. In some implementations, various steps of method 100 can be run in parallel, in combination, in loops, and/or in any order.

At 102, gas pressure gradient data including fluid temperatures and pressures at multiple depths are obtained. In a typical implementation, the gas pressure gradient data is obtained by performing a gradient survey operation where pressure and temperature gauges are run in the wellbore to measure fluid (or gas) temperatures and pressures at multiple depths. The gas pressure gradient data can also be obtained by other methods or operations as will be understood by those of ordinary skill in the art. Consistent with this disclosure, these other methods or operations are also considered to be within the scope of this disclosure.

From the gas pressure gradient data, a gas pressure gradient can be calculated which represents a change in pressure with a change in depth. For example, the gas pressure gradient can be determined using the measured temperatures and pressures at an initial depth and a final depth of a reservoir interval of interest as follows:

$${σ}_{g} = \frac{{P}_{f} - {P}_{i}}{{D}_{f} - {D}_{i}} , \qquad ( 8 )$$

where:

σ_{g} is the gas pressure gradient (psi/ft),

Pᵢ is the pressure at the initial depth (psi),

P_{f} is the pressure at the final depth (psi),

Dᵢ is the initial depth (ft), and

D_{f} is the final depth (ft).

FIG. 2 illustrates gas pressure gradient data 200, according to an implementation. The gas pressure gradient data 200 shows measured fluid pressures 202 at different depths 204. The gas pressure gradient σ_{g} can be calculated as the pressure difference 206 between the initial and the final depths divided by the depth difference 208. Returning to FIG. 1, from 102, method 100 proceeds to 104.

At 104, the z-factor is derived based on the gas pressure gradient data. The derivation uses Boyle's law and Charles' law which describe the relationship between a volume occupied by a gas and its pressure and temperature. Boyle's law states that for a given mass of gas at a constant temperature, the pressure-volume product is constant. Charles' law states that for a given mass of gas at a constant pressure, the ratio of volume to temperature is constant. A combination of these two laws becomes an equation of state (EOS) for ideal gases as follows:

PV=znRT (9),

where:

P is the pressure (psia),

V is the volume (ft³),

n is the number of moles,

R is the universal gas constant, 10.73 psia ft³/lb-mole,

T is the temperature (R°), and

z is the z-factor.

The number of moles n can also be expressed in terms of gas mixture mass and molecular weight as follows:

$$n = \frac{m}{{MM}_{a}} . \qquad ( 10 )$$

where:

m is the gas mixture mass.

Substituting equation (10) in (9) yields the following:

$$\begin{matrix}PV = z \frac{m}{{MM}_{a}} RT & ( 11 ) \\ {PMM}_{a} = z \frac{m}{V} RT . & ( 12 )\end{matrix}$$

The gas pressure gradient can also be expressed in terms of gas density as follows:

$${σ}_{g} = \frac{{ρ}_{g}}{144} = \frac{m}{144 V} , \qquad ( 13 )$$

where:

ρ_{g} is the gas density.

Combining equations (12) and (13) and solving for the z-factor yields the following:

$$z = \frac{{PMM}_{a}}{144 {σ}_{g} RT} . \qquad ( 14 )$$

Substituting equation (8) in (14) yields the z-factor as a function of gas pressure gradient data as follows:

$${z}_{avg} = \frac{{P}_{avg} MMa}{144 {σ}_{g} {RT}_{avg}} = \frac{{P}_{avg} {MM}_{a} ( {D}_{f} - {D}_{i} )}{144 ( {P}_{f} - {P}_{i} ) {RT}_{avg}} , \qquad ( 15 )$$

where:
z_{avg} is the average z-factor across the reservoir interval,
P_{avg} is the average pressure across the reservoir interval, and
T_{avg} is the average temperature in R° across the reservoir interval.

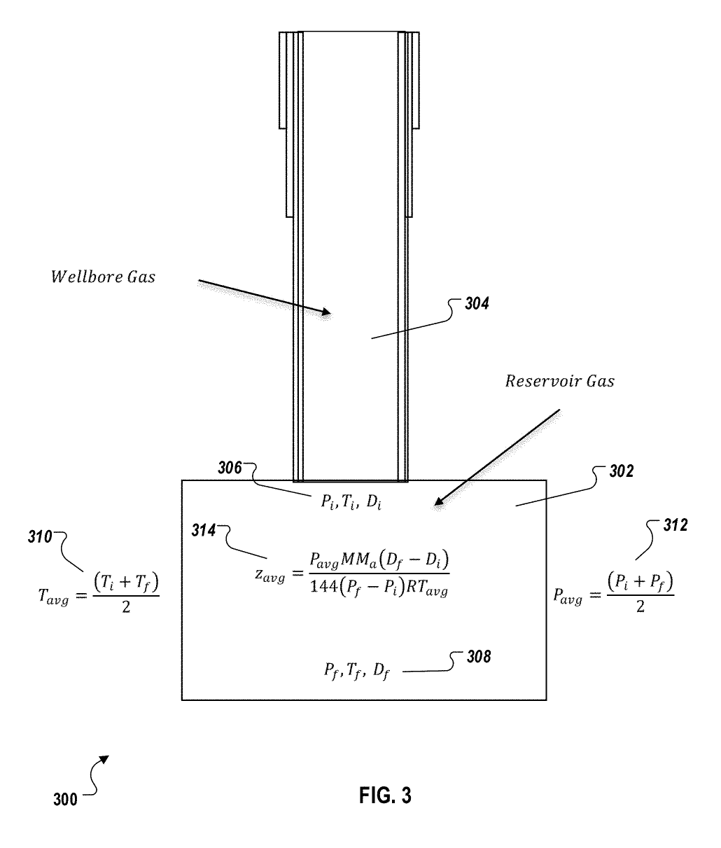

FIG. 3 illustrates a z-factor calculation 300 across a reservoir interval, according to an implementation. The calculation 300 can be applied to reservoir gas 302 below wellbore gas 304. The input parameters to the calculation 300 can include measured pressure, temperature, and depth at an initial depth 306 and measured pressure, temperature, and depth at a final depth 308 of the reservoir. An average temperature 310 can be calculated by averaging the temperatures at the initial and final depths. An average pressure 312 can be calculated by averaging the pressures at the initial and final depths. The z-factor 314 of the reservoir interval can be calculated based on the measured pressures and temperatures at the initial and final depths, the average temperature 310, and the average pressure 312.

Although equation (15) expresses the z-factor as a function of gas pressure gradient data, it may still need experimental analysis to determine the gas mixture molecular weight MMa. To avoid the experimental analysis, an iterative methodology based on equation (15) can be used to calculate the z-factor.

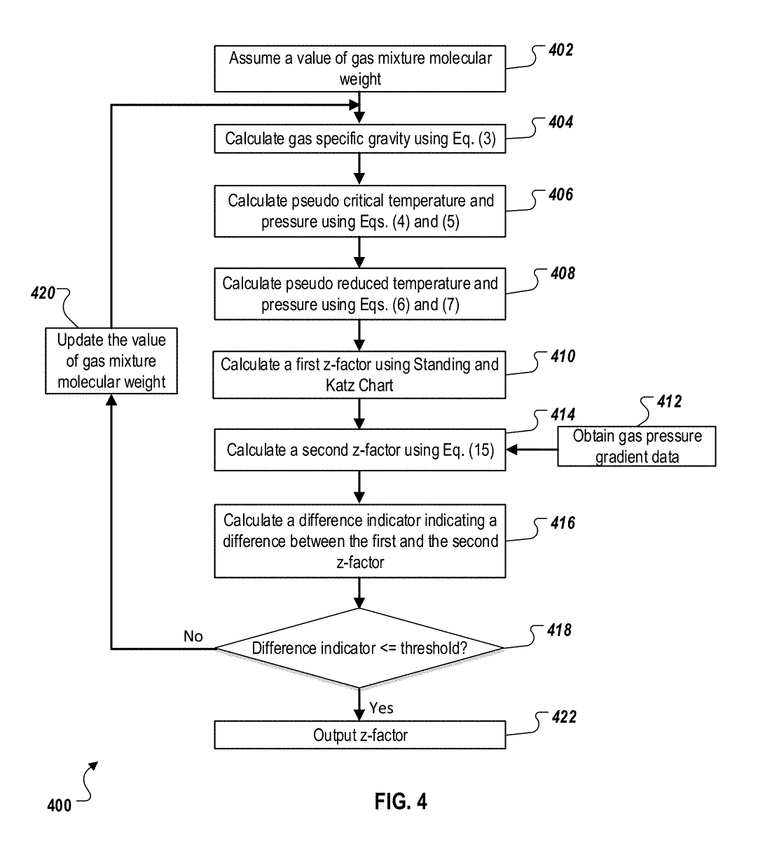

FIG. 4 is a flow chart of an example method 400 to numerically calculate a z-factor using an iterative methodology, according to an implementation. For clarity of presentation, the description that follows generally describes method 400 in the context of FIGS. 1-3 and 5. However, it will be understood that method 400 may be performed, for example, by any suitable system, environment, software, and hardware, or a combination of systems, environments, software, and hardware as appropriate. In some implementations, various steps of method 400 can be run in parallel, in combination, in loops, and/or in any order.

At 402, a gas mixture molecular weight is assumed. In a typical implementation, the gas mixture molecular weight MMa is assumed to 16 g/lb-mole (i.e., Methane MMa), which is the least possible value of the gas mixture molecular weight. As will be understood by those of ordinary skill in the art, MMa can also be assumed to other values. Consistent with this disclosure, these other assumed values of MMa are also considered to be within the scope of this disclosure. From 402, method 400 proceeds to 404.

At 404, a gas specific gravity is calculated based on the assumed value of MMa using equation (3). From 404, method 400 proceeds to 406.

At 406, pseudo critical temperature and pressure are calculated based on the gas specific gravity using equations (4) and (5). From 406, method 400 proceeds to 408.

At 408, pseudo reduced temperature and pressure are calculated based on the pseudo critical temperature and pressure using equations (6) and (7). From 408, method 400 proceeds to 410.

At 410, a first z-factor is determined from the Standing and Katz chart as a function of pseudo reduced pressure and temperature. From 410, method 400 proceeds to 414.

At 412, gas pressure gradient data is obtained. In a typical implementation, the gas pressure gradient data can be obtained by performing a gradient survey operation. The gas pressure gradient data can include measured temperatures and pressures at multiple depths, e.g., an initial depth and a final depth of the reservoir interval of interest. From 412, method 400 proceeds to 414.

At 414, a second z-factor is calculated using equation (15) based on the gas pressure gradient data and the assumed value of MMa. Parameters in equation (15), including average pressure P_{avg}, average temperature T_{avg}, and/or gas pressure gradient σ_{g} across the reservoir interval, can be determined or calculated based on the gas pressure gradient data. From 414, method 400 proceeds to 416.

At 416, a difference indicator indicating a difference between the two z-factors is calculated. In a typical implementation, a relative difference between the two z-factors is calculated as follows:

$$Relative difference \% = \frac{\vert 1 st z \text{-} factor - 2 nd z \text{-} factor \vert}{1 st z \text{-} factor} \times 100. \qquad ( 16 )$$

As will be understood by those of ordinary skill in the art, other methods can be used to calculate the difference indicator representing the difference between the two z-factors. Consistent with this disclosure, these other methods are also considered to be within the scope of this disclosure. From 416, method 400 proceeds to 418.

At 418, the difference indicator is compared with a predefined threshold. If the difference indicator is more than the threshold, the z-factor is not considered to be converged; method 400 proceeds to 420 to update the assumed value of gas mixture molecular weight MMa and calculate updated z-factor values by repeating 404 to 416. If the difference indicator is less than or equal to the threshold, the z-factor is considered to be converged; method 400 proceeds to 422 to stop the iteration and output the z-factor. As will be understood by those of ordinary skill in the art, various threshold values can be used. Consistent with this disclosure, these other threshold values are also considered to be within the scope of this disclosure. In a typical implementation, a threshold value of 0.001% can be used for the relative difference in equation (16). In some implementations, the threshold value can be chosen based on a target number of iterations and/or a target level of accuracy of the z-factor. For example, a large threshold value can be used if a small number of iterations is preferred. In another example, a small threshold value can be used if a high level of accuracy of the z-factor is desired.

At 420, the value of the assumed gas mixture molecular weight is updated. In a typical implementation, the gas mixture molecular weight MMa at the (i+1)^{th} iteration is updated based on the MMa value at the i^{th} iteration, e.g., MMaᵢ₊₁=MMaᵢ+Δ, where the amount of update Δ can be a pre-determined value. In a typical implementation, Δ can be 0.01. In some implementations, Δ can be chosen based on the target number of iterations and/or the targeted level of accuracy of z-factor. For example, a large Δ value can be used if a small number of iterations is desired. In another example, a small Δ value can be used if a high level of accuracy of z-factor is desired. In some implementations, a constant Δ value can be used during the iterative process of method 400. In other implementations, the Δ value can change during the iterative process. For example, a large Δ value may be used at a first few iterations and a small Δ value can be used after the difference between the two z-factors is smaller than a certain threshold. From 420, method 400 proceeds to 404 and repeats 404 to 418 to calculate updated z-factors using the updated MMa value from 420.

At 422, the converged z-factor is outputted. For example, the outputted z-factor value can be the first z-factor in the last iteration, the second z-factor in the last iteration, or an average of the first and second z-factors in the last iteration. As will be understood by those of ordinary skill in the art, other values to represent the converged z-factor can also be used. Consistent with this disclosure, these other values used to represent the converged z-factor are also considered to be within the scope of this disclosure. The outputted z-factor can be further used to calculate other gas properties of the reservoir interval.

In some implementations, a number of iterations can be specified and the condition at 418 can be replaced by the number of iterations larger than the specified number of iterations. In these implementations, the method 400 is performed until the number of iterations reaches the specified number of iterations and the z-factor value corresponding to the minimum difference among all iterations is outputted.

The example method 400 has been applied on the following two actual field cases with known PVT data from experimental analysis to validate the z-factor computed by the example method 400.

Case A is a wet gas well producing from a reservoir at 11790 ft. The reservoir pressure is above the dew point. Table 1 presents gas pressure gradient data of Case A. As shown in the table, the reservoir interval in Case A has an initial depth of 11500 ft. and a final depth of 11790 ft. Table 2 shows gas PVT data of Case A and a z-factor value of 0.1107 is obtained by using the existing approach based on PVT experimental analysis. The example method 400 using the gas gradient data in Table 1 yields a z-factor value of 1.108. The corresponding relative difference as calculated in equation (16) is 2.01%.

TABLE 1
Gas pressure gradient data of Case A

| Depth | | | Average | Average | Average Gas |
|---|---|---|---|---|---|
| (ft- | Pressure | Temperature | Pressure | Temperature | Gradient |
| TVD) | (psi) | (F.) | (psi) | R | (psi/ft) |
| 11500 | 5935.09 | 254.66 | 5942.575 | 714.93 | 0.1107 |
| 11790 | 5967.19 | 255.92 | | | |

TABLE 2
Gas PVT data of Case A

| Reservoir | Reservoir | |
|---|---|---|
| Pressure (psi) | Temperature (F. °) | Z-Factor |
| 5900 | 248 | 1.131 |

Case-B is a wet gas well producing from a reservoir at 8300 ft. The reservoir pressure is below the dew point. Table 3 presents gas pressure gradient data of Case B. As shown in the table, the reservoir interval in Case B has an initial depth of 8000 ft. and a final depth of 8300 ft. Table 4 shows gas PVT data of Case B and a z-factor value of 1.047 is obtained by using the existing approach based on PVT experimental analysis. The example method 400 using the gas gradient data in Table 3 yield a z-factor value of 0.995. The corresponding relative difference as calculated in equation (16) is 4.93%.

TABLE 3
Gas pressure gradient data of Case B

| Depth | | | Average | Average | Average Gas |
|---|---|---|---|---|---|
| (ft- | Pressure | Temperature | Pressure | Temperature | Gradient |
| TVD) | (psi) | (F.) | (psi) | R | (psi/ft) |
| 8000 | 4930 | 220 | 4951 | 681.5 | 0.1400 |
| 8300 | 4972 | 223 | | | |

TABLE 4
Gas PVT data of Case B

| Reservoir | Reservoir | |
|---|---|---|
| Pressure (psi) | Temperature (F. °) | Z-Factor |
| 4900 | 259 | 1.047 |

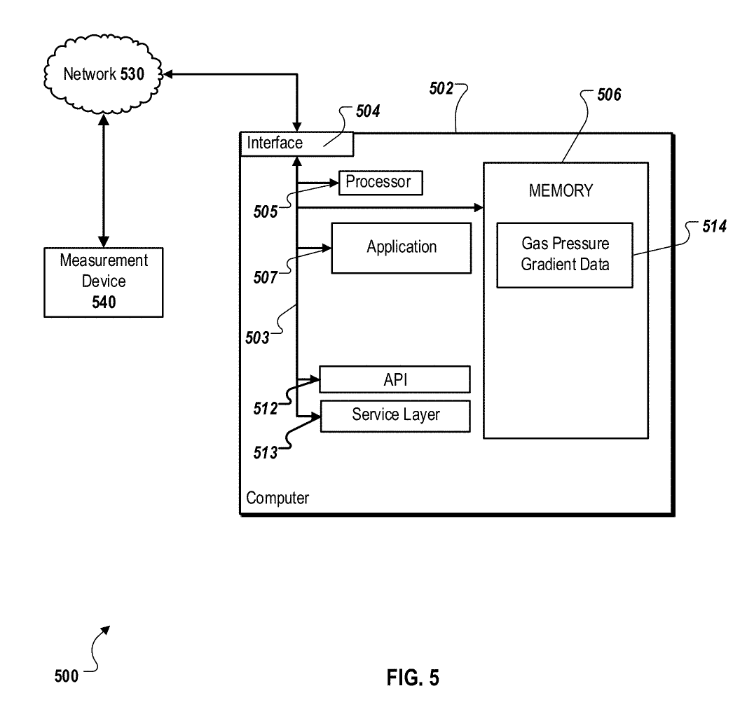

FIG. 5 is a block diagram illustrating an exemplary distributed computer system (EDCS) 500 used to numerically calculate gas properties without reservoir fluid characterization according to an implementation. In some implementations, the EDCS 500 includes a computer 502, network 530, and measurement device 540.

The illustrated computer 502 is intended to encompass a computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. The computer 502 may comprise a computer that includes an input device, such as a keypad, keyboard, touch screen, or other device (not illustrated) that can accept user information, and an output device (not illustrated) that conveys information associated with the operation of the computer 502, including digital data, visual and/or audio information, or a user interface.

The computer 502 can serve as a client and/or a server. In typical implementations, the computer 502 act as either a parallel processing node, host for a software agent, and/or a host for a database, user interface, numerical calculation application, and/or other applications consistent with this disclosure (even if not illustrated). The illustrated computer 502 is communicably coupled with a network 530. In some implementations, one or more components of the computer 502 may be configured to operate within a parallel-processing and/or cloud-computing-based environment. Implementations of the computer 502 can also communicate using message passing interface (MPI) or other interface over network 530.

At a high level, the computer 502 is an electronic computing device operable to receive, transmit, process, store, or manage data and information associated with numerical calculation of gas properties without reservoir fluid characterization. According to some implementations, the computer 502 may also include or be communicably coupled with a simulation server, application server, e-mail server, web server, caching server, streaming data server, business intelligence (BI) server, and/or other server.

The computer 502 can receive requests over the network 530 from an application 507 (e.g., executing on another computer 502) and respond to the received requests by processing the said requests in an appropriate software application 507. In addition, requests may also be sent to the computer 502 from internal users (e.g., from a command console or by other appropriate access methods), external or third-parties, other automated applications, as well as any other appropriate entities, individuals, systems, or computers.

Each of the components of the computer 502 can communicate using a system bus 503. In some implementations, any and/or all the components of the computer 502, both hardware and/or software, may interface with each other and/or the interface 504 over the system bus 503 using an application programming interface (API) 512 and/or a service layer 513. The API 512 may include specifications for routines, data structures, and object classes. The API 512 may be either computer-language independent or dependent and refer to a complete interface, a single function, or even a set of APIs. The service layer 513 provides software services to the computer 502 and/or system of which the computer 502 is a part. The functionality of the computer 502 may be accessible for all service consumers using this service layer. Software services, such as those provided by the service layer 513, provide reusable, defined business functionalities through a defined interface. For example, the interface may be software written in JAVA, C++, or other languages providing data in extensible markup language (XML) format or other formats. While illustrated as an integrated component of the computer 502, alternative implementations may illustrate the API 512 and/or the service layer 513 as stand-alone components in relation to other components of the computer 502. Moreover, any or all parts of the API 512 and/or the service layer 513 may be implemented as child or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502. The interface 504 is used by the computer 502 for communicating with other systems in a distributed environment—including a parallel processing environment—connected to the network 530 (whether illustrated or not). Generally, the interface 504 comprises logic encoded in software and/or hardware in a suitable combination and operable to communicate with the network 530. More specifically, the interface 504 may comprise software supporting one or more communication protocols associated with communications over network 530.

The computer 502 includes a processor 505. Although illustrated as a single processor 505 in FIG. 5, two or more processors may be used according to particular needs, desires, or particular implementations of the computer 502. Generally, the processor 505 executes instructions and manipulates data to perform the operations of the computer 502. Specifically, the processor 505 executes the functionality required for numerical calculation of gas properties without reservoir fluid characterization.

The computer 502 also includes a memory 506 that holds data for the computer 502 and/or other components of a system of which the computer is a part. Although illustrated as a single memory 506 in FIG. 5, two or more memories may be used according to particular needs, desires, or particular implementations of the computer 502. While memory 506 is illustrated as an integral component of the computer 502, in alternative implementations, memory 506 can be external to the computer 502. In some implementations, memory 506 can hold and/or reference one or more of, as described above, gas pressure gradient data 514.

The application 507 is an algorithmic software engine providing functionality according to particular needs, desires, or particular implementations of the computer 502 and/or a system of which the computer 502 is a part, particularly with respect to functionality required for numerical calculation of gas properties without reservoir fluid characterization. For example, application 507 can serve as (or a portion of) a database, user interface, numerical calculation application, and/or other application consistent with this disclosure (whether illustrated or not). Although illustrated as a single application 507, the application 507 may be implemented as multiple applications 507 on the computer 502. In addition, although illustrated as integral to the computer 502, in alternative implementations, the application 507 can be external to and execute apart from the computer 502.

There may be any number of computers 502 associated with a computer system performing functions consistent with this disclosure. Further, the term “client,” “user,” and other appropriate terminology may be used interchangeably as appropriate without departing from the scope of this disclosure. Moreover, this disclosure contemplates that many users/processes may use one computer 502, or that one user/process may use multiple computers 502.

Measurement device 540 is operable to at least measure gas pressure gradient data. The gas pressure gradient data can include fluid temperatures and pressures at multiple depths, e.g., an initial depth and a final depth of a reservoir interval. In some implementations, a measurement device 540 can be a pressure gauge that runs in a wellbore to measure fluid temperatures and pressures at multiple depths. Measurement device 540 can be other types of measurement devices as will be understood by those of ordinary skill in the art. Consistent with this disclosure, these other measurement devices are also considered to be within the scope of this disclosure.

In some implementations, gas pressure gradient data recorded by a measurement device 540 may also be transferred over network 530 to a remote data storage location (not illustrated) instead of being stored in memory 506. Although illustrated as communicably connected (e.g., by a cable, wireless connection, etc.) through network 530 to computer 502, in some implementations, a measurement device 540 may also be integrated into computer 502 and/or other components (not illustrated) of computer system 500 or directly connected to an interface port (not illustrated) on computer 502. While the computer system 500 is illustrated as containing a single measurement device 540, alternative implementations of computer system 500 may include any number of measurement devices 540, working individually or in concert, and suitable to the purposes of the EDCS 500. In some implementations, measurement device(s) 540 can be part of a mechanical assembly (not illustrated) for moving, adjusting, stabilizing, etc. the measurement device(s) 540 to obtain the gas pressure gradient data.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatuses, devices, and machines for processing data, including by way of example, a programmable processor, a computer, or multiple processors or computers. The apparatus can also be or further include special purpose logic circuitry, e.g., a central processing unit (CPU), a co-processor (e.g., a graphics/visual processing unit (GPU/VPU)), a FPGA (field programmable gate array), or an ASIC (application specific integrated circuit). In some implementations, the data processing apparatus and/or special purpose logic circuitry may be hardware-based and/or software-based. The apparatus can optionally include a code that creates an execution environment for computer programs, e.g., a code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other units suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto optical disks; and CD ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other types of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of UI elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other language providing data in extensible markup language (XML) format or other format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving gas pressure gradient data of a reservoir interval;
initializing a gas mixture molecular weight; and
iteratively calculating, by a computer, a gas deviation factor of the reservoir interval, wherein the iterative calculation includes:
calculating a first gas deviation factor using a gas specific gravity based on the gas mixture molecular weight;
calculating a second gas deviation factor based on the gas mixture molecular weight and the gas pressure gradient data;
calculating a difference indicator indicating difference between the first and the second gas deviation factor;
updating the gas mixture molecular weight based on the difference indicator;
re-calculating the first and the second gas deviation factor and the difference indicator based on the updated gas mixture molecular weight; and
outputting the gas deviation factor when the difference indicator is smaller than a pre-determined threshold.

2. The method of claim 1, wherein the gas pressure gradient data includes fluid temperatures and pressures at an initial depth and a final depth of the reservoir interval.

3. The method of claim 2, wherein the second gas deviation factor is calculated as
$$\frac{{P}_{avg} MMa ( {D}_{f} - {D}_{i} )}{144 ( {P}_{f} - {P}_{i} ) {RT}_{avg}} ,$$
where
$${P}_{avg} = \frac{{P}_{i} + {P}_{f}}{2}$$
is an average pressure across the reservoir interval
$${T}_{avg} = \frac{{T}_{i} + {T}_{f}}{2}$$
is an average temperature across the reservoir interval, Dᵢ and D_{f} are the initial and the final depth of the reservoir interval, respectively, Pᵢ and P_{f} are fluid pressures at the initial and the final depth of the reservoir interval, respectively, Tᵢ and T_{f} are fluid temperatures at the initial and the final depth of the reservoir interval, respectively, MMₐ is the gas mixture molecular weight, and R is a universal gas constant.

4. The method of claim 1, wherein calculating the first gas deviation factor using the gas specific gravity based on the gas mixture molecular weight further comprises:
calculating pseudo critical temperature and pressure based on the gas specific gravity;
calculating pseudo reduced temperature and pressure based on the pseudo critical temperature and pressure; and
calculating the first gas deviation factor from Standing and Katz charts based on the pseudo reduced temperature and pressure.

5. The method of claim 1, wherein updating the gas mixture molecular weight includes increasing the gas mixture molecular weight by a pre-determined amount.

6. The method of claim 1, wherein outputting the gas deviation factor includes outputting one of the first gas deviation factor, the second gas deviation factor, or an average of the first and the second gas deviation factor.

7. The method of claim 1, wherein initializing the gas mixture molecular weight includes initializing the gas mixture molecular weight to a least possible value of gas mixture molecular weight.

8. A non-transitory, computer-readable medium storing computer-readable instructions, the instructions executable by a computer and configured to:
receive gas pressure gradient data of a reservoir interval;
initialize a gas mixture molecular weight; and
iteratively calculate, by a computer, a gas deviation factor of the reservoir interval, wherein the iterative calculation includes:
calculating a first gas deviation factor using a gas specific gravity based on the gas mixture molecular weight;
calculating a second gas deviation factor based on the gas mixture molecular weight and the gas pressure gradient data;
calculating a difference indicator indicating difference between the first and the second gas deviation factor;
updating the gas mixture molecular weight based on the difference indicator;
re-calculating the first and the second gas deviation factor and the difference indicator based on the updated gas mixture molecular weight; and
outputting the gas deviation factor when the difference indicator is smaller than a pre-determined threshold.

9. The non-transitory, computer-readable medium of claim 8, wherein the gas pressure gradient data includes fluid temperatures and pressures at an initial depth and a final depth of the reservoir interval.

10. The non-transitory, computer-readable medium of claim 9, wherein the second gas deviation factor is calculated as
$$\frac{{P}_{avg} MMa ( {D}_{f} - {D}_{i} )}{144 ( {P}_{f} - {P}_{i} ) {RT}_{avg}} ,$$
where
$${P}_{avg} = \frac{{P}_{i} + {P}_{f}}{2}$$
is an average pressure across the reservoir interval,
$${T}_{avg} = \frac{{T}_{i} + {T}_{f}}{2}$$
is an average temperature across the reservoir interval, Dᵢ and D_{f} are the initial and the final depth of the reservoir interval, respectively, Pᵢ and P_{f} are fluid pressures at the initial and the final depth of the reservoir interval, respectively, Tᵢ and T_{f} are fluid temperatures at the initial and the final depth of the reservoir interval, respectively, MMₐ is the gas mixture molecular weight, and R is a universal gas constant.

11. The non-transitory, computer-readable medium of claim 8, wherein calculating the first gas deviation factor using the gas specific gravity based on the gas mixture molecular weight further comprises:
calculating pseudo critical temperature and pressure based on the gas specific gravity;
calculating pseudo reduced temperature and pressure based on the pseudo critical temperature and pressure; and
calculating the first gas deviation factor from Standing and Katz charts based on the pseudo reduced temperature and pressure.

12. The non-transitory, computer-readable medium of claim 8, wherein updating the gas mixture molecular weight includes increasing the gas mixture molecular weight by a pre-determined amount.

13. The non-transitory, computer-readable medium of claim 8, wherein outputting the gas deviation factor includes outputting one of the first gas deviation factor, the second gas deviation factor, or an average of the first and the second gas deviation factor.

14. The non-transitory, computer-readable medium of claim 8, wherein initializing the gas mixture molecular weight includes initializing the gas mixture molecular weight to a least possible value of gas mixture molecular weight.

15. A system, comprising:
a computer memory;
a hardware processor interoperably coupled with the computer memory and configured to:
receive gas pressure gradient data of a reservoir interval;
initialize a gas mixture molecular weight; and
iteratively calculate, by a computer, a gas deviation factor of the reservoir interval, wherein the iterative calculation includes:
calculating a first gas deviation factor using a gas specific gravity based on the gas mixture molecular weight;
calculating a second gas deviation factor based on the gas mixture molecular weight and the gas pressure gradient data;
calculating a difference indicator indicating difference between the first and the second gas deviation factor;
updating the gas mixture molecular weight based on the difference indicator;
re-calculating the first and the second gas deviation factor and the difference indicator based on the updated gas mixture molecular weight; and
outputting the gas deviation factor when the difference indicator is smaller than a pre-determined threshold.

16. The system of claim 15, wherein the gas pressure gradient data includes fluid temperatures and pressures at an initial depth and a final depth of the reservoir interval.

17. The system of claim 16, wherein the second gas deviation factor is calculated as
$$\frac{{P}_{avg} MMa ( {D}_{f} - {D}_{i} )}{144 ( {P}_{f} - {P}_{i} ) {RT}_{avg}} ,$$
where
$${P}_{avg} = \frac{{P}_{i} + {P}_{f}}{2}$$
is an average pressure across the reservoir interval
$${T}_{avg} = \frac{{T}_{i} + {T}_{f}}{2}$$
is an average temperature across the reservoir interval, Dᵢ and D_{f} are the initial and the final depth of the reservoir interval, respectively, Pᵢ and P_{f} are fluid pressures at the initial and the final depth of the reservoir interval, respectively, Tᵢ and T_{f} are fluid temperatures at the initial and the final depth of the reservoir interval, respectively, MMₐ is the gas mixture molecular weight, and R is a universal gas constant.

18. The system of claim 15, wherein calculating the first gas deviation factor using the gas specific gravity based on the gas mixture molecular weight further comprises:
calculating pseudo critical temperature and pressure based on the gas specific gravity;
calculating pseudo reduced temperature and pressure based on the pseudo critical temperature and pressure; and
calculating the first gas deviation factor from Standing and Katz charts based on the pseudo reduced temperature and pressure.

19. The system of claim 15, wherein updating the gas mixture molecular weight includes increasing the gas mixture molecular weight by a pre-determined amount.

20. The system of claim 15, wherein initializing the gas mixture molecular weight includes initializing the gas mixture molecular weight to a least possible value of gas mixture molecular weight.
